(19) United States
(12) Patent Application Publication
(10) Pub. No.: US 2014/0164988 A1
(43) Pub. Date: Jun. 12, 2014

(54) IMMERSIVE VIEW NAVIGATION

(71) Applicant: MICROSOFT CORPORATION, Redmond, WA (US)

(72) Inventors: Donald A. Barnett, Monroe, WA (US); Tair Barkay, San Francisco, CA (US); Gonzalo Alberto Ramos, Kirkland, WA (US)

(73) Assignee: Microsoft Corporation, Redmond, WA (US)

(21) Appl. No.: 13/706,715

(22) Filed: Dec. 6, 2012

(51) Int. Cl. G06F 3/0481

(52) U.S. Cl. CPC G06F 3/0481
USPC 715/790

(57) ABSTRACT

Among other things, one or more techniques and/or systems are provided for immersive navigation between one or more views. That is, an immersive user interface may display a first view (e.g., an image) depicting one or more entities (e.g., a person, a location, an object, a building, etc.). Responsive to a user expressing interest in (e.g., selecting) a first entity depicted within the first view, the immersive user interface may display one or more views depicting the first entity without removing the user from an immersive experience (e.g., the immersive user interface may remain in a substantially full-screen view mode, a substantially edge-to-edge view mode, a 3-D mode, etc.). Responsive to the user expressing interest in (e.g., selecting) a second entity depicted within a currently displayed view, the immersive user interface may display one or more views depicting the second entity without removing the user from the immersive experience.

### BACKGROUND

Many users consume content, such as images, through computing devices (e.g., personal computers, mobile devices, tablet devices, etc.). In an example, a user may view, upload, organize, and/or share images through a social network website. In another example, a user may create a digital image album through a photo organization application. In another example, a user may browse images from various sources through a web search portal. Unfortunately, a user may be transitioned into and/or out of an immersive environment when switching between various classifications of images, such as images from different sources and/or images depicting different entities.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for immersive navigation between one or more views are provided herein. It may be appreciated that in an example, a view may correspond to an image (e.g., a photo of a national park, a digitally drawn scene of a beach, a scanned image of a document, a snapshot of a desktop environment, an image of a person, a zoomed-in state of (e.g., a portion of) an image and/or a variety of other digitalized imagery). The view may depict one or more entities, such as people, places, and/or things (e.g., a business, a tree, a person, a building, the sun, a beach, a national park, a business, a field, a car, etc.). As provided herein, immersive navigation between one or more views may be facilitated for an immersive view interface. The immersive view interface may selectively present one or more views based upon one or more entities that are depicted by such views. For example, responsive to a user indicating that a car entity is of particular interest to the user (e.g., a gesture, such as targeting user input, is received that selects the car entity within a first view), a second view that depicts the car entity (e.g., at a similar or different time, at a similar or different location and/or in a zoomed-in state) may be obtained and/or displayed through the immersive view interface. In this way, the user may navigate amongst one or more views depicting the first entity, such as the car entity (e.g., the user may navigate to a new view depicting Jim driving a sports car along a winding road), and may then navigate amongst one or more views depicting a second entity, such as a Jim entity, without leaving an immersive state, such as a substantially full screen mode (e.g., the user may navigate to a new view of Jim at the beach based upon second targeting user input expressing a change in interest from the sports car to Jim).

In an example of immersive navigation, a first view may be displayed within an immersive view interface (e.g., the first view may be displayed in a substantially edge-to-edge view mode to provide a user with an immersive experience). The first view may depict one or more entities (e.g., an image depicting a lifeguard tower, Jim, a water-body, and an ice-cream shop on a beach). In an example, responsive to a first targeting user input associated with a first entity within the first view (e.g., the lifeguard tower), the first entity may be selected, regarded, etc. as a pivot point (e.g., an entity around which one or more views may be pivoted) and/or the first view may be (e.g., optionally) transitioned into a zoomed-in state focused on the first entity. In another example, a default pivot point (e.g., a location entity, an object entity, a person entity, time, etc.) may be used as the pivot point where first targeting user input is not detected. Responsive to a first navigation input through a pivot control overlay (e.g., an input control associated with the immersive view interface, which may accept input without removing the user from the immersive experience), the immersive view interface may be transitioned from the first view to a second view (e.g., a different image depicting the lifeguard tower and a red truck at nighttime) based upon the second view depicting the first entity of the lifeguard tower. For example, the second view may be selectively obtained from an image repository based upon the second view depicting the first entity (e.g., a graph representing entities, views, and/or relationships may be traversed to identify the second view). In this way, the user may navigate through one or more views associated with the first entity without leaving the immersive experience.

In an example, the user may navigate from the second view (e.g., displayed based upon the second view depicting the first entity of the lifeguard tower) to a third view based upon the third view depicting a second entity (e.g., an image of the red truck on a farm), where the second entity is also depicted within the second view (e.g., the red truck at nighttime), without leaving the immersive experience. For example, responsive to a second targeting user input associated with the second entity depicted within the second view (e.g., the red truck at nighttime), the second entity may be selected, regarded, etc. as the pivot point and/or the second view may be (e.g., optionally) transitioned into a second zoomed-in state focusing on the second entity (e.g., a focus of the second view may be transitioned to the red truck). Responsive to a second navigation input through the pivot control overlay, the immersive view interface may be transitioned from the second view to the third view based upon the third view depicting the second entity (e.g., transitioned from the image of the red truck at nighttime to the image of the red truck on the farm). In this way, the user may explore various views without leaving the immersive state (e.g., the first view, the second view, and/or the third view may be displayed without taking the user out of an immersive state, such as a substantially full screen view mode, a substantially edge-to-edge view mode, a 3-D mode, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of immersive navigation between one or more views.

FIG. 2 is a component block diagram illustrating an exemplary system for immersive navigation between one or more views.

FIG. 3 is a component block diagram illustrating an exemplary system for immersive navigation between one or more views.

FIG. 4 is a component block diagram illustrating an exemplary system for immersive navigation between one or more views.

FIG. 5 is a component block diagram illustrating an exemplary system for immersive navigation between one or more views.

FIG. 6 is a component block diagram illustrating an exemplary system for immersive navigation between one or more views.

FIG. 7 is an illustration of an exemplary computing device-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

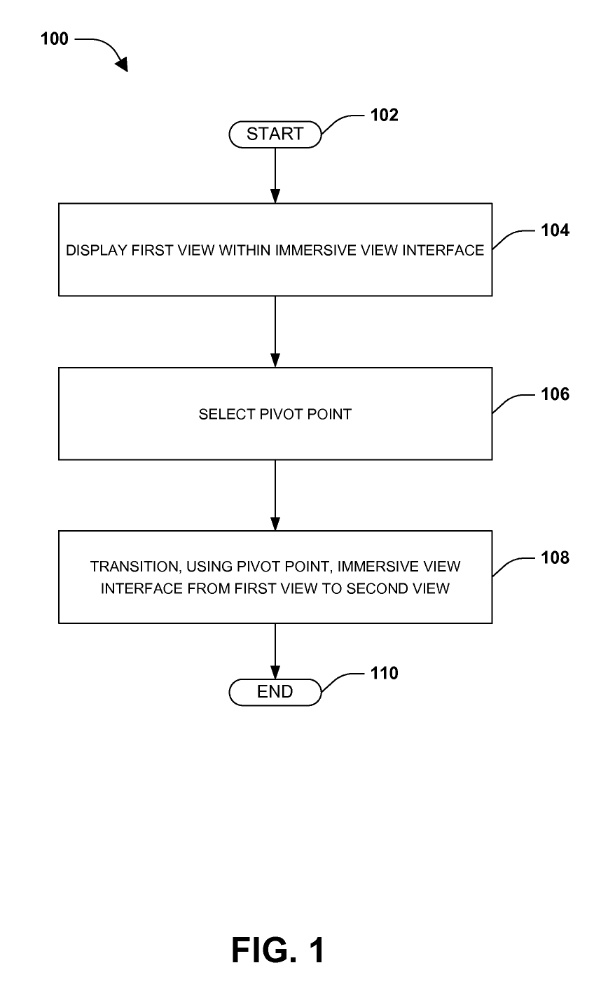

One embodiment of immersive navigation between one or more views is illustrated by an exemplary method 100 in FIG. 1. At 102, the method starts. At 104, a first view may be displayed within an immersive view interface (e.g., an image viewing application, a search website, a social network, etc.). The first view may comprise one or more entities (e.g., a person, a location, an object, etc.). For example, a first image depicting Jim, a sports car, and a national forest lodge may be displayed through the immersive view interface. In an example, the first image may be displayed within a substantially full screen view mode, an edge-to-edge view mode, a 3-D mode and/or any other mode(s), which may provide a user with an immersive experience. At 106, a first entity within the first view may be selected as a pivot point. For example, responsive to a first targeting user input associated with the first entity within the first view (e.g., receipt of an indication of a user selection of the national forest lodge), the first entity may be selected, regarded, etc. as a pivot point and/or the first view may be (e.g., optionally) transitioned into a zoomed-in state relative to the first entity (e.g., the national forest lodge may be brought into a main focus of the first view). In another example, a default pivot point (e.g., a location entity, a person entity, an object entity, time, etc.) may be used as the pivot point (e.g., where no targeting user input is detected). In an example, a pivot control overlay may be displayed that can be used to pivot around the pivot point (e.g., view different views based upon the different views comprising the pivot point). For example, responsive to a selection input associated with the first entity depicted within the first view (e.g., in the first zoomed-in state), a pivot control overlay may be displayed (e.g., without navigating the user away from the immersive view interface and/or the immersive experience). The pivot control overlay may allow the user to navigate through one or more views depicting the first entity. In an example, the selection input may correspond to the first targeting user input such that the pivot control overlay is displayed upon receipt of the first targeting user input. In another example, the pivot control overlay may be displayed once the first view is displayed within the immersive view interface (e.g., by default as opposed to in response to the selection input and/or the first targeting user input).

At 108, responsive to a first navigation input through the pivot control overlay, the immersive view interface may be transitioned, using the pivot point, from the first view (e.g., in the first zoomed-in state) to a second view based upon the second view depicting the first entity (e.g., a second image depicting the national forest lodge, Sue, and a bear), where the second view may or may not be in a zoomed-in state with regard to the first entity (e.g., the national forest lodge may or may not be focused on in the second view). In an example, the second view may be identified within an image repository (e.g., an image repository that may be similar or different than a source of the first view) based upon traversing a graph comprising one or more nodes (e.g., representing views and/or entities) and/or one or more edges (e.g., representing relationships between views and/or entities). In another example, a filter, such as a time filter (e.g., a year filter), a person filter (e.g., a Sue filter), a location filter (e.g., a forest filter), and/or an object type filter (e.g., a car filter) may be used to identify the second view. For example, the time filter may specify a 1 year time span, such that the second view may be identified based upon the second view having been created within 1 year from the first view. The user may perform various operations associated with the second view, such as a zoom-out operation that may transition the second view from a zoomed-in state to a zoomed-out state that may depict a third entity that was not depicted by the second view while in a zoomed-in state. In this way, the user may navigate through one or more views depicting the first entity, may see different views (e.g., images) depicting the first entity along with other entities (e.g., at different times, locations, etc.) and/or may navigate back to the first view based upon a cancel input.

In an example, the user may navigate from a current view displayed by the immersive view interface to a new view without leaving the immersive experience based upon the new view depicting a second entity that is depicted by the current view. For example, responsive to a second targeting user input associated with the second entity depicted within the second view (e.g., Sue depicted in the second image), the second entity may be selected as the pivot point and/or the second view may be (e.g., optionally) transitioned into a second zoomed-in state with regard to the second entity (e.g., Sue may be brought to a main focus of the second image). Responsive to a second navigation input through the pivot control overlay, the immersive view interface may be transitioned, using the pivot point (e.g., the second entity), from the second view in the second zoomed-in state to a third view based upon the third view depicting the second entity (e.g., a third image depicting Sue at school). The third view may or may not depict the first entity (e.g., the third image may not depict the national forest lodge) and the second entity may or may not be in a zoomed-in state in the third view. In this way, the user may navigate through one or more views depicting the second entity (e.g., by using the pivot control overlay) without leaving the immersive experience (e.g., a fourth view depicting Sue on a running trail). At 110, the method ends.

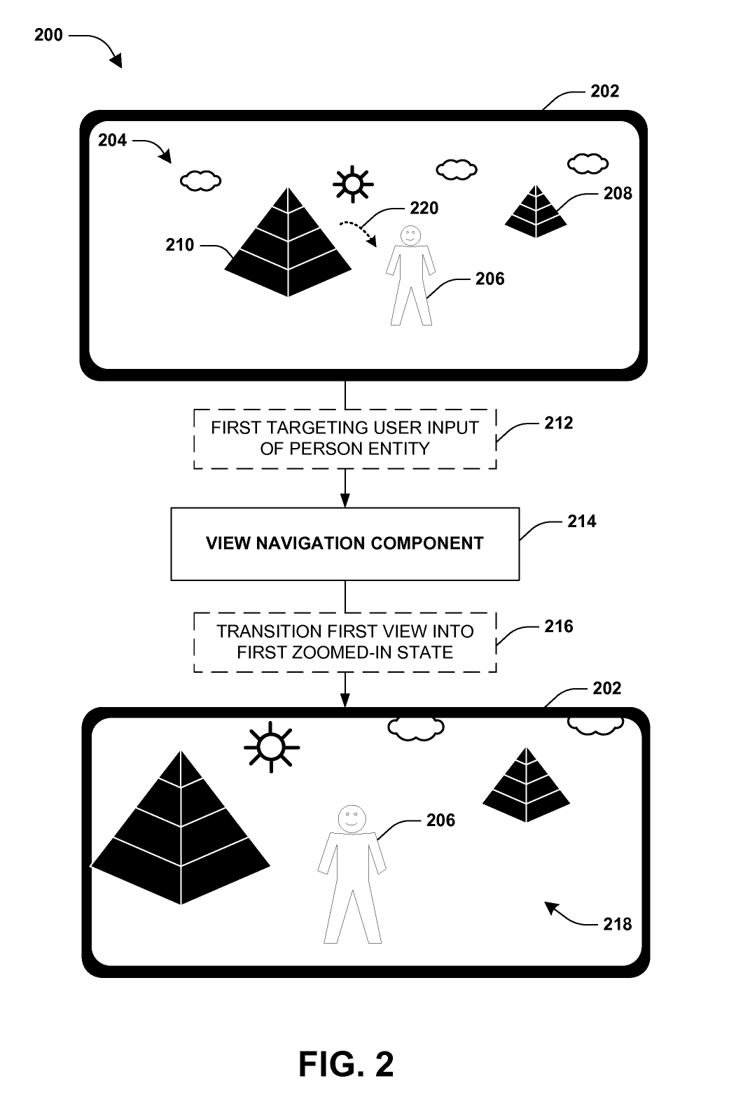

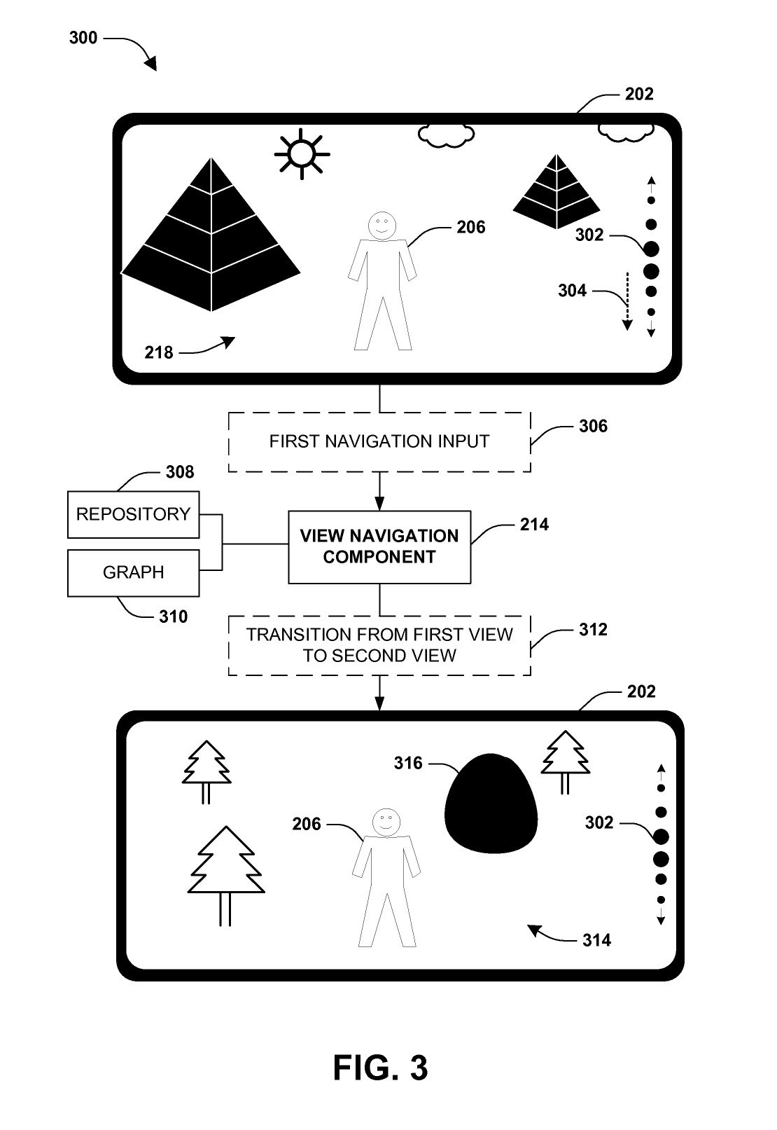

FIG. 2 illustrates an example of a system 200 configured for immersive navigation between one or more views. The system 200 may comprise a view navigation component 214. The view navigation component 214 may be associated with an immersive view interface 202. The immersive view interface 202 may display a first view 204 depicting a first pyramid entity 210, a second pyramid entity 208, a person entity 206, and/or other entities. The view navigation component 214 may be configured to detect 212 a first targeting user input 220 (e.g., a gesture, a mouse click, a pause, etc.) associated with a first entity, such as the person entity 206. The view navigation component 214 may be configured to regard the person entity 206 as a pivot point. In an example, the view navigation component 214 may transition 216 the first view 204 into a zoomed-in state 218 with regard to the person entity 206 based upon the first targeting user input 220. In this way, the user may navigate through one or more views depicting the person entity 206 without leaving the immersive view interface 202 and/or an immersive experience, such as a substantially full-screen view mode and/or a substantially edge-to-edge view mode (e.g., as illustrated by FIG. 3).

FIG. 3 illustrates an example of a system 300 configured for immersive navigation between one or more views. It may be appreciated that in an example, the system 300 may correspond to the system 200 of FIG. 2. For example, the system 300 may comprise a view navigation component 214 that may be associated with an immersive view interface 202. The immersive view interface 202 may display a first view within a zoomed-in state 218 (e.g., the first view may be focused on a first entity, such as the person entity 206, based upon first targeting user input 220 associated with the person entity 206 of FIG. 2). In an example, a pivot control overlay 302 may be associated with the immersive view interface 202. The view navigation component 214 may be configured to detect 306 a first navigation input 304 through the pivot control overlay 302 (e.g., a swipe gesture, a mouse click, etc.). Responsive to the first navigation input 304, the view navigation component 214 may identify a second view 314 that depicts the person entity 206. For example, a repository 308 (e.g., an online image database, image search engine results, social network data, a folder, etc.) may be searched for the second view 314 based upon traversing a graph 310 to identify one or more views that depict the person entity 206. In this way, the view navigation component 214 may transition 312 the immersive view interface 202 from the first view in the zoomed-in state 218 to the second view 314 depicting the person entity 206 and/or other entities, such as a lake entity 316. That is, pivoting among different views may occur around the person entity 206 (e.g., pivot point). The person entity 206 may or may not be focused on in the second view 314 (e.g., the second view may not be in a zoomed-in state with regard to the person entity until targeting user input associated with the person entity within the second view 314 is received).

It may be appreciated that the pivot control overlay 302 may be used to pivot around various types of entities and/or dates. In an example, the pivot control overlay 302 may be used to transition the immersive view interface 202 from a first view of a scene depicting a desert during the day to a second view of the scene depicting the desert at night (e.g., pivot around time associated with the desert). Accordingly, a pivot point need not be limited to merely an explicit entity (e.g., person, car, etc.) but may be more comprehensive of a scene (e.g., scene of the desert). In this way, the immersive view interface 202 may be transitioned through various scenes depicting the desert at various times and/or dates. In another example, the pivot control overlay 302 may be used to transition the immersive view interface 202 from a first view of a first scene depicting a person entity to a second view of a second scene depicting the person entity at a later point in time (e.g., in a different location than a location of the first scene), such as a year later (e.g., pivot around time associated with the person entity based upon yearly time spans). In this way, the immersive view interface 202 may be transitioned through various scenes depicting the person entity over one or more years (e.g., the first view may depict the person entity on a 30^{th} birthday, the second view may depict the person entity on a 31^{st} birthday, a third view may depict the person entity on a 32^{nd} birthday, etc.).

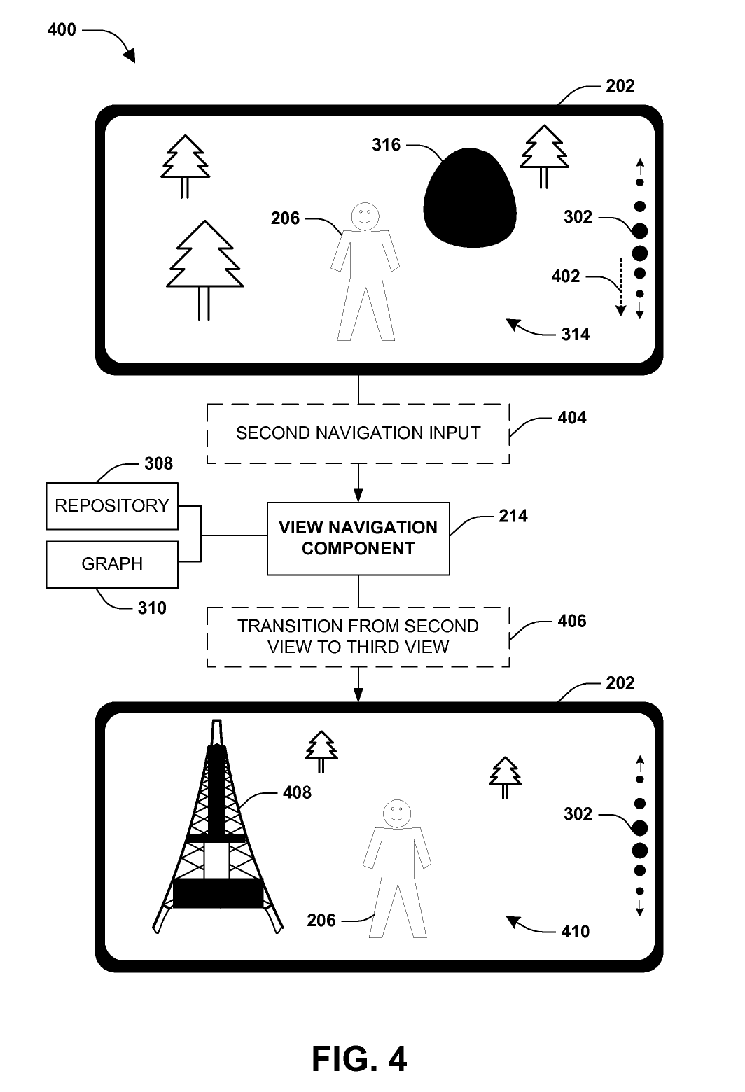

FIG. 4 illustrates an example of a system 400 configured to immersive navigation between one or more views. It may be appreciated that in an example, the system 400 may correspond to the system 300 of FIG. 3. For example, the system 400 may comprise a view navigation component 214 that may be associated with an immersive view interface 202. The immersive view interface 202 may display a second view 314 that may depict a first entity, such as the person entity 206, and/or other entities, such as a lake entity 316. In an example, a pivot control overlay 302 may be associated with the immersive view interface 202. The view navigation component 214 may be configured to detect 404 a second navigation input 402 through the pivot control overlay 302 (e.g., a swipe gesture, a mouse click, etc.). Responsive to the second navigation input 402, the view navigation component 214 may identify a third view 410 that depicts the person entity 206. For example, a repository 308 may be searched for the third view 410 based upon traversing a graph 310 to identify one or more views that depict the person entity 206. In this way, the view navigation component 214 may transition 406 the immersive view interface 202 from the second view to the third view 410 depicting the person entity 206 (e.g., pivot point) and/or other entities, such as a tower entity 408. The third view 410 may or may not be in a zoomed-in state with regard to the person entity 206.

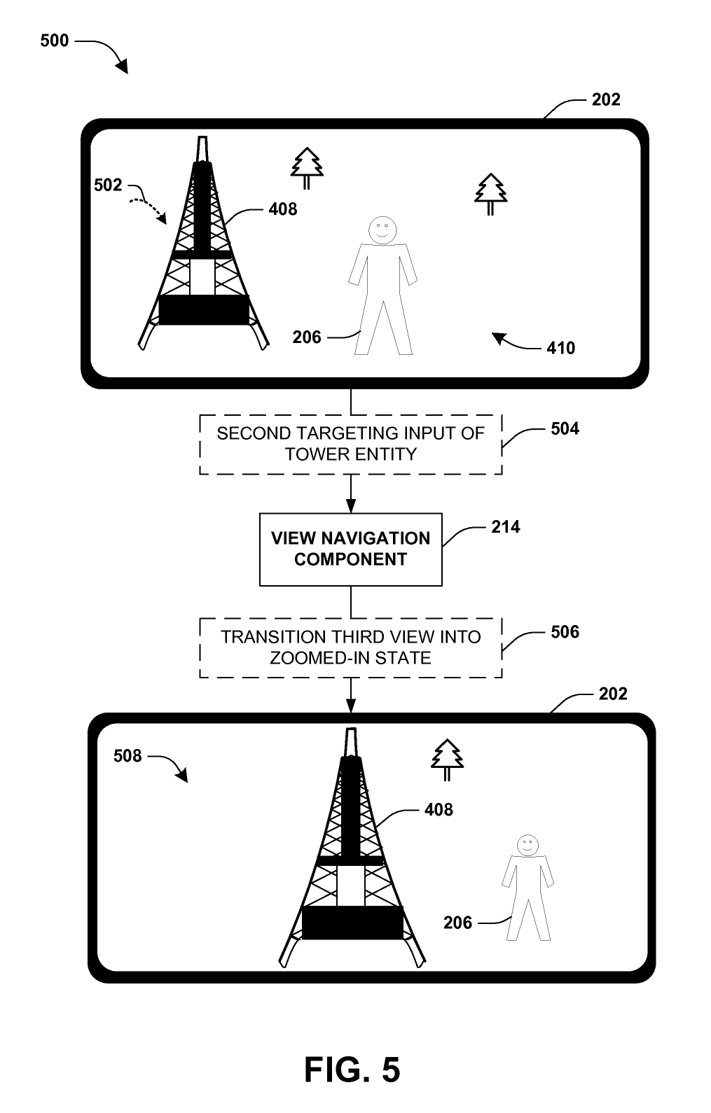

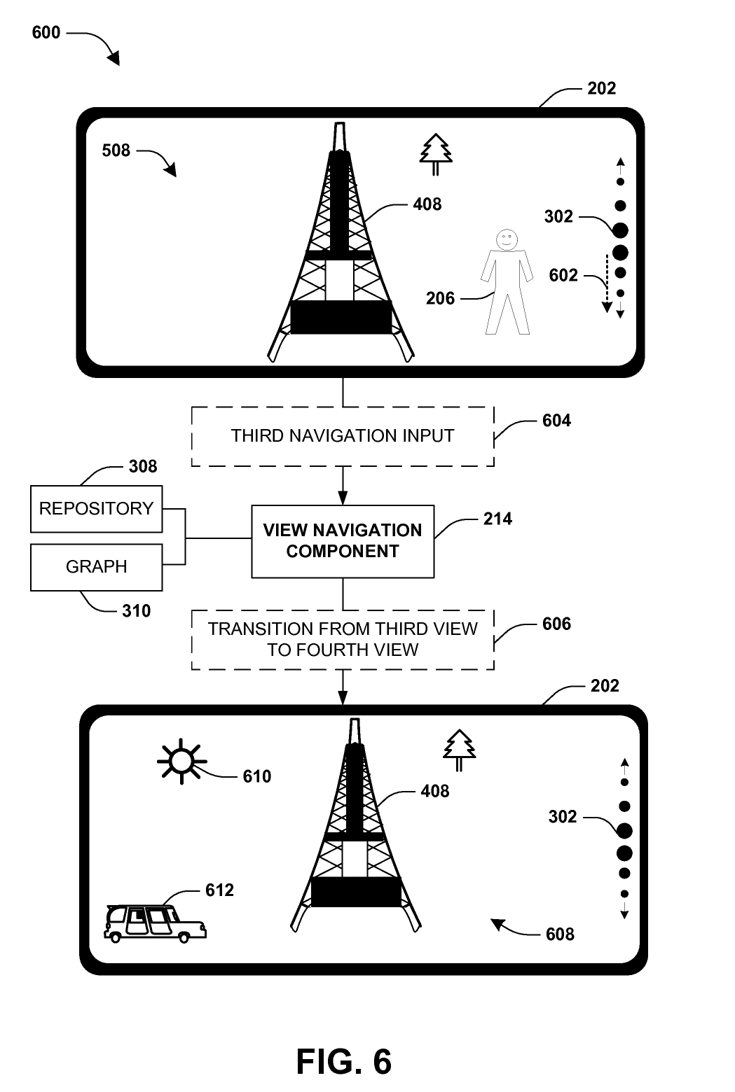

FIG. 5 illustrates an example of a system 500 configured for immersive navigation between one or more views. It may be appreciated that in an example, the system 500 may correspond to the system 400 of FIG. 4. For example, the system 500 may comprise a view navigation component 214 that may be associated with an immersive view interface 202. The immersive view interface 202 may display a third view 410 that may depict a first entity (e.g., a person entity 206), a second entity (e.g., a tower entity 408), and/or other entities. The view navigation component 214 may be configured to detect 504 a second targeting user input 502 associated with the second entity, such as the tower entity 408. The view navigation component 214 may be configured to regard the tower entity 408 (e.g., instead of the person entity 206) as a pivot point. In an example, the view navigation component 214 may transition 506 the third view 410 into a zoomed-in state 508 with regard to the tower entity 408 based upon the second targeting user input 502. In this way, the user may navigate through one or more views depicting the tower entity 408 (e.g., which may or may not depict the first entity, such as the person entity 206) without leaving the immersive view interface 202 and/or an immersive experience, such as a substantially full-screen view mode and/or an edge-to-edge view mode (e.g., as illustrated by FIG. 6). That is, the user may navigate from viewing one or more views depicting the first entity to one or more views depicting the second entity without leaving the immersive experience.

FIG. 6 illustrates an example of a system 600 configured for immersive navigation between one or more views. It may be appreciated that in an example, the system 600 may correspond to the system 500 of FIG. 5. For example, the system 600 may comprise a view navigation component 214 that may be associated with an immersive view interface 202. The immersive view interface 202 may display a third view in a zoomed-in state 508 that may depict a second entity (e.g., a tower entity 408) as a main focus (e.g., based upon a second targeting input 502 of FIG. 5). In an example, a pivot control overlay 302 may be associated with the immersive view interface 202. The view navigation component 214 may be configured to detect 604 a third navigation input 602 through the pivot control overlay 302. Responsive to the third navigation input 602, the view navigation component 214 may identify a fourth view 608 based upon the fourth view 608 depicting the tower entity 408 (e.g., the fourth view 608 may depict the tower entity 408, a sun entity 610, and/or a car entity 612, but may not depict the person entity 206). For example, a repository 308 may be searched for the fourth view 608 based upon traversing a graph 310 to identify one or more views that depict the tower entity 408. Accordingly, the view navigation component 214 may transition 606 the immersive view interface 202 from the third view (e.g., which was initially displayed based upon the person entity 206 being a pivot point) to the fourth view 410 which is displayed based upon the tower entity 408 being the pivot point. The fourth view 410 may or may not be in a zoomed-in state with regard to the tower entity 206. In this way, the user may navigate from viewing one or more views depicting the first entity to one or more views depicting the second entity without leaving the immersive experience.

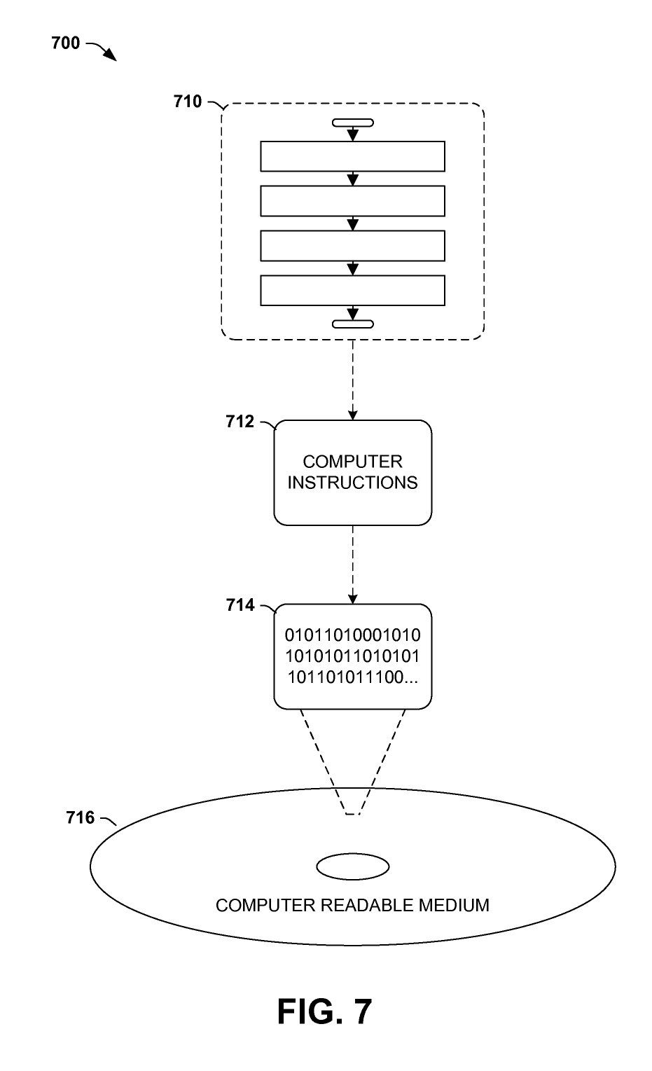

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as at least some of the exemplary method 100 of FIG. 1, for example. In another such embodiment, the processor-executable instructions 712 may be configured to implement a system, such as at least some of the exemplary system 200 of

FIG. 2, at least some of the exemplary system 300 of FIG. 3, at least some of the exemplary system 400 of FIG. 4, at least some of the exemplary system 500 of FIG. 5, and/or at least some of the exemplary system 600 of FIG. 6, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

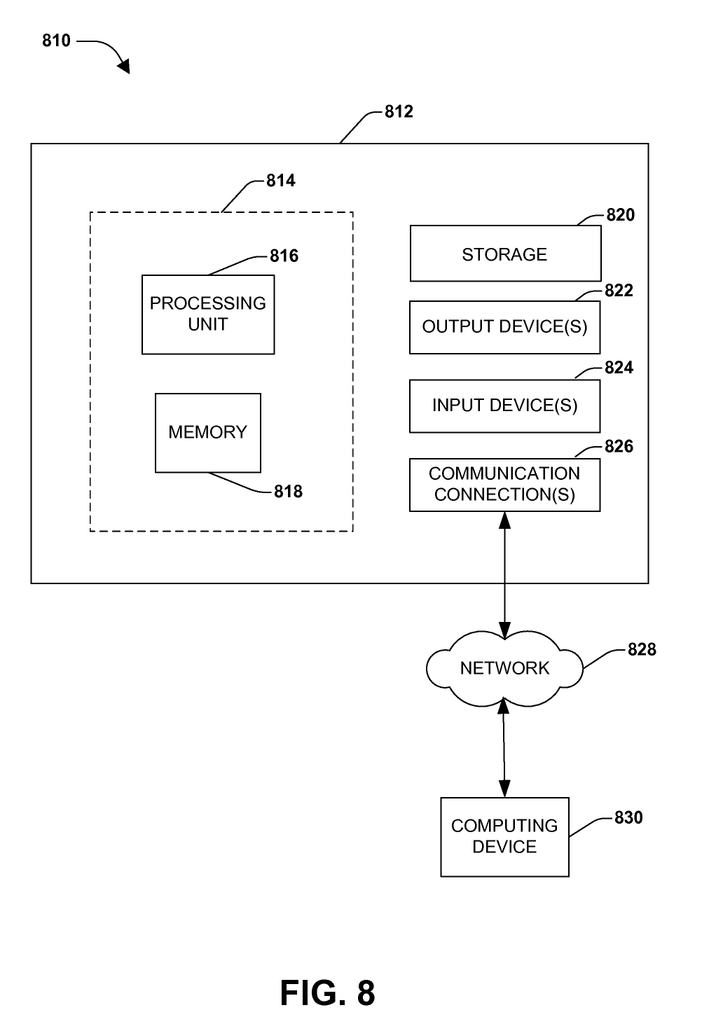

FIG. 8 and the following discussion provide a brief, general description of a suitable computing environment to implement embodiments of one or more of the provisions set forth herein. The operating environment of FIG. 8 is only an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for immersive navigation between one or more views, comprising:
displaying a first view within an immersive view interface, the first view depicting one or more entities;
responsive to a first targeting user input associated with a first entity within the first view, selecting the first entity as a pivot point; and
responsive to a first navigation input through a pivot control overlay, transitioning, using the pivot point, the immersive view interface from the first view to a second view based upon the second view depicting the first entity.

2. The method of claim 1, comprising:
responsive to a second navigation input through the pivot control overlay, transitioning, using the pivot point, the immersive view interface from the second view to a third view based upon the third view depicting the first entity.

3. The method of claim 1, the second view depicting a second entity, and the method comprising:
responsive to a second targeting user input associated with the second entity within the second view, selecting the second entity as the pivot point; and
responsive to a second navigation input through the pivot control overlay, transitioning, using the pivot point, the immersive view interface from the second view to a third view based upon the third view depicting the second entity.

4. The method of claim 3, the third view not depicting the first entity.

5. The method of claim 3, comprising:
responsive to a third navigation input through the pivot control overlay, transitioning, using the pivot point, the immersive view interface from the third view to a fourth view based upon the fourth view depicting the second entity.

6. The method of claim 1, the selecting the first entity as a pivot point comprising:
transitioning the first view into a first zoomed-in state with regard to the first entity.

7. The method of claim 1, at least one of:
the immersive view interface comprising an edge-to-edge display of the first view; or
the immersive view interface comprising an edge-to-edge display of the second view.

8. The method of claim 1, the second view displayed within a zoomed-in state, and the method comprising:
responsive to a zoom-out input associated with the second view, transitioning the second view into a zoomed-out state comprising a third entity not depicted by the second view while in the zoomed-in state.

9. The method of claim 1, the first view comprising a first image and the second view comprising a second image.

10. The method of claim 1, the transitioning the immersive view interface from the first view to a second view comprising:
identifying the second view based upon a filter comprising at least one of a time filter, a person filter, a location filter, or an object type filter.

11. The method of claim 1, the first entity comprising a person,
the first view depicting the person at least one of:
a first location, or
a first time, and
the second view depicting the person at least one of:
a second location different than the first location, or
a second time different than the first time.

12. The method of claim 1, the first entity comprising an object, the first view depicting the object at a first location at a first time and the second view depicting the object at the first location at a second time.

13. The method of claim 2, comprising:
responsive to receiving a cancel input, transitioning the immersive view interface from the third view to the first view.

14. The method of claim 1, the transitioning the immersive view interface from the first view to a second view comprising:
identifying the second view within an image repository based upon traversing a graph comprising one or more nodes and one or more edges, a node representing a view, an edge between two nodes representing a relationship between two views represented by the two nodes.

15. The method of claim 1, the transitioning the immersive view interface from the first view to a second view comprising:
obtaining the second view from a second source that is different than a first source from which the first view was obtained.

16. A system for immersive navigation between one or more views, comprising:
a view navigation component configured to:
display a first view within an immersive view interface, the first view depicting one or more entities;
responsive to a first targeting user input associated with a first entity within the first view, selecting the first entity as a pivot point; and
responsive to a first navigation input through a pivot control overlay, transition, using the pivot point, the immersive view interface from the first view to a second view based upon the second view depicting the first entity.

17. The system of claim 16, the view navigation component configured to:
responsive to a second targeting user input associated with a second entity depicted within the second view, selecting the second entity as the pivot point; and
responsive to a second navigation input through the pivot control overlay, transition, using the pivot point, the immersive view interface from the second view to a third view based upon the third view depicting the second entity.

18. The system of claim 16, the view navigation component configured to:
identify the second view within an image repository based upon traversing a graph comprising one or more nodes and one or more edges, a node representing a view, an edge between two nodes representing a relationship between two views represented by the two nodes.

19. A computer readable medium comprising instructions which when executed at least in part via a processing unit perform a method for immersive navigation between one or more views, comprising:
displaying a first view within an immersive view interface, the first view depicting one or more entities;
identifying a default pivot point as a pivot point, the default pivot point corresponding to at least one of a location entity, a person entity, an object entity, or time; and
responsive to a first navigation input through a pivot control overlay, transitioning, using the pivot point, the immersive view interface from the first view to a second view.

20. The computer readable medium of claim 19, the second view depicting a second entity, and the method comprising:
responsive to a second targeting user input associated with the second entity within the second view, selecting the second entity as the pivot point; and
responsive to a second navigation input through the pivot control overlay, transitioning, using the pivot point, the immersive view interface from the second view to a third view based upon the third view depicting the second entity.
